(19) United States
(12) Patent Application Publication
(10) Pub. No.: US 2026/0077457 A1
(43) Pub. Date: Mar. 19, 2026

(54) BIT HOLDER

(71) Applicant: Stanley Black & Decker MEA FZE, Dubai (AE)

(72) Inventor: Kai-Chun CHANG, Taichung City (TW)

(21) Appl. No.: 19/331,245

(22) Filed: Sep. 17, 2025

(30) Foreign Application Priority Data
Sep. 17, 2024 (EP) 24200723.5

(51) Int. Cl. B25B 23/00

(52) U.S. Cl. CPC B25B 23/0035

(57) ABSTRACT

A bit holder includes a sleeve having a bore for receiving a bit and a through-hole in a wall of the sleeve connected to the bore. A magnet is arranged to engage the bit and wherein the magnet is moveable within the bore between a first position when the bit is seated in the bore and a second position when the bit is partially ejected from the bore. A magnet retaining element is mounted in the through-hole and arranged to protrude into the bore and engage a portion of the magnet when the magnet is in the second position.

This application claims priority from European Application No. 24200723.5, filed September 17, 2024, the disclosures of which are incorporated herein by reference in their entirety.

### BACKGROUND OF THE INVENTION

The present disclosure relates to a bit holder. In particular, the present disclosure relates to a locking bit holder for screwdriver bits.

A user may require different screwdriver tools depending on the type of fastener head. The user may encounter many different fastener head types on a worksite, so the user may need to quickly change the bit required. Bit holders are known and permit the quick change of bits for screwdriver tools.

US 8,308,168 B2 discloses such a tool bit holder. The tool bit holder comprises a retaining tooth which is movable into engagement with the bit when the bit is inserted into the bore to retain the bit. The tool bit holder has an ejector that comprises a spring that is compressed when the bit is inserted in the bore and a push button is biased by the spring into engagement with the bit. A sleeve forces the retaining tooth into engagement with the bit when said sleeve is in the locking position. A problem with this arrangement is that the tool bit holder comprises many small parts which makes assembly difficult during manufacture.

### Brief Summary of the Invention

Examples of the present disclosure aim to address the aforementioned problems.

According to an aspect of the present disclosure there is a bit holder comprising: a sleeve having a bore for receiving a bit and a through-hole in a wall of the sleeve connected to the bore; a magnet arranged to engage the bit and wherein the magnet is moveable within the bore between a first position when the bit is seated in the bore and a second position when the bit is partially ejected from the bore; and a magnet retaining element mounted in the through-hole and arranged to protrude into the bore and engage a portion of the magnet when the magnet is in the second position.

Optionally, the bit holder comprises a magnet spring arranged to urge the magnet from the first position towards the second position.

Optionally, the magnet retaining element is a clip.

Optionally, the clip is a C-clip, or an E-clip.

Optionally, the magnet comprises a shoulder portion arranged to engage the magnet retaining element when the magnet is in the second position.

Optionally, the through-hole extends through the wall of the sleeve in a direction perpendicular to a longitudinal axis of the bit holder.

Optionally, the magnet projects through the magnet retaining element in a direction parallel with a longitudinal axis of the bit holder when the magnet is in the second position.

Optionally, the magnet is arranged to move from the second position to the first position when a bit is inserted into the bore.

Optionally, the bit holder comprises a bit locking element arranged to protrude into the bore and engage a reciprocal notch on the bit when the bit is seated in the bore and the magnet is in the first position.

Optionally, the bit locking element is mounted in a locking element through-hole in the wall of the sleeve.

Optionally, the locking mechanism comprises a release collar slidably mounted on the sleeve and arranged to disengage the bit locking element from the reciprocal notch when the release collar is moved from a locked position to a release position.

Optionally, the release collar covers the through-hole.

Optionally, the release collar comprises a collar spring arranged to urge the release collar from the release position to the locked position.

Optionally, the retaining element and comprises at least one flat surface arranged to engage a reciprocal flat surface on the sleeve.

Optionally, the sleeve comprises a circumferential groove arranged to receive the retaining element.

### Brief Description of the Drawings

Various other aspects and further examples are also described in the following detailed description and in the attached claims with reference to the accompanying drawings, in which:

FIG. 1 shows a perspective view of the bit holder according to some examples;

FIG. 2 shows a perspective view of a partially assembled bit holder according to some examples;

FIG. 3a shows an exploded perspective view of a bit holder according to some examples;

FIG. 3b shows a perspective view of a component of the bit holder according to some examples; and

FIGS. 4a and 4b show a cross-sectional side view of a bit holder respectively with a bit seated in the bit holder and with a bit partially ejected from the bit holder according to some examples.

### Detailed Description of the Preferred Embodiments

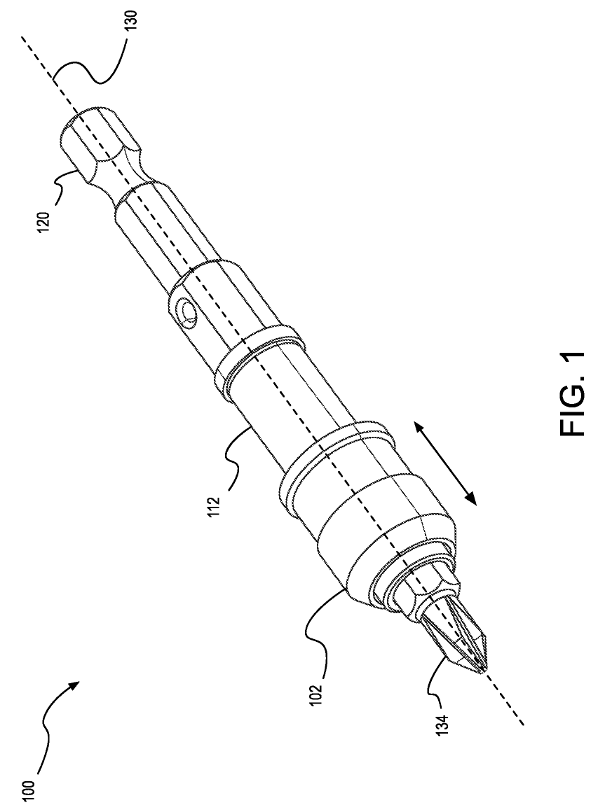

FIG. 1 shows a perspective view of a bit holder 100. The bit holder 100 is arranged to secure a bit 134 in a sleeve 112. The bit 134 is selectively released from the sleeve 112 by a collar 102. The collar 102 is arranged to slide along the sleeve 112 in order to release the bit 134 from the sleeve 112.

The sleeve 112 is mounted to a bar 120. In some examples, the bar 120 is fixed to the sleeve 112 and no relative movement is permitted between the bar 120 and the sleeve 112. In some examples, the bar 120 is welded to the sleeve 112. In other examples, the bar 120 is fastened to the sleeve 112 is a suitable fastener e.g. a rivet. In other examples, the sleeve 112 is attached to the bar 120 with a friction fit. The bar 120 is arranged to be received in a tool, e.g. a chuck or tool holder of a power tool (not shown). As shown in FIG. 1, the bar 120 comprises a hexagonal profile, which provides for secure engagement with the chuck or tool holder of a power tool.

The bit holder 100 extends along a longitudinal axis 130. As shown in FIG. 1, the collar 102 is slidably moveable in a direction parallel with the longitudinal axis 130, indicated by the arrow in FIG. 1.

The bit 134 as shown in FIG. 1 and the other figures is a crosshead bit which is suitable for engagement with e.g. a crosshead type fastener. In order to allow the user to engage other types of fastener head, the bit 134 is releasable from the bit holder 100. Indeed, any suitable type of bit 134 (e.g. a flat head bit, a hexagonal bit, a star shaped bit, or any other shaped bit, etc.) can be used with the bit holder 100.

As shown in FIG. 1, the bit 134 has a hexagonal cross-sectional profile. The sleeve 112 comprises a sleeve bore 146 for receiving the bit 134. The sleeve bore 146 comprises a reciprocal hexagonal cross-sectional shape in order to securely receive the bit 134 and transmit torque from the bit holder 100 to the bit 134.

Whilst the bit 134 is shown as a bit 134 with a hexagonal cross-sectional profile, other bits 134 with a different cross-sectional profile can be used if the sleeve bore 146 also has a corresponding cross-sectional shape.

As mentioned above, the bit 134 is selectively released from the bit holder 100 by the collar 102. The bit 134 is securely locked to the bit holder 100 when fully seated in the sleeve bore 146.

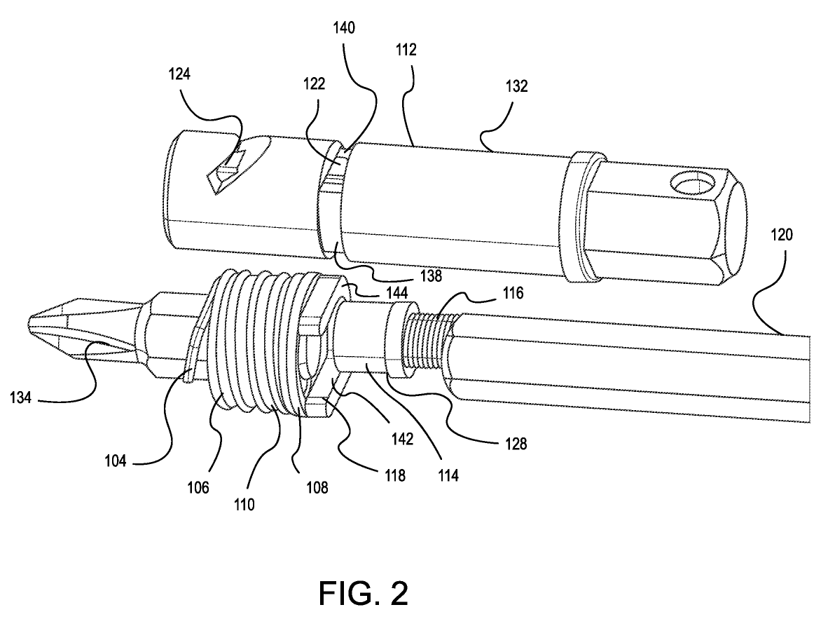

The mechanism for locking the bit 134 in the bit holder 100 will now be discussed in more detail with reference to FIG. 2. FIG. 2 shows a perspective view of the partially assembled bit holder 100. The sleeve 112, has been shown remote from the other components for the purposes of clarity.

The bit 134 is securely held within the sleeve 112 with a bit locking element 104. The bit locking element 104 is arranged to engage a reciprocal notch 136 in the bit 134 when the bit 134 is fully inserted into the sleeve 112.

The bit locking element 104 is movable between an engaged position wherein the bit locking element 104 engages a reciprocal notch 136 on the bit 134 and a released position wherein the bit locking element 104 does not physically engage the reciprocal notch 136. When the bit locking element 104 is engaged with the reciprocal notch 136 of the bit 134, the bit 134 is fixed with respect to the sleeve 112 and cannot move in a direction parallel with the longitudinal axis 130. When the bit locking element 104 is disengaged, the bit 134 is free to move in a direction parallel with the longitudinal axis 130.

As shown in FIG. 2, the bit locking element 104 is a U-shaped element. However, the bit locking element 104 can have any suitable shape which engages the reciprocal notch 136 in the bit 134.

The bit locking element 104 is mounted within a locking element through hole 124 in the sleeve 112. The locking element through hole 124 is a hole which goes through a sleeve wall 132 of the sleeve 112. The locking element through hole 124 is orientated in a direction which is at an angle to the longitudinal axis 130 of the bit holder 100.

As shown in FIG. 2, the bit locking element 104 sits within the locking element through hole 124, when the bit holder 100 is assembled. The bit locking element 104 is coupled to the collar 102. Accordingly, the bit locking element 104 moves together with the collar 102 when the collar 102 slides along the sleeve 112 in the direction as shown in FIG. 1.

As shown in FIG. 1, the collar 102 is in a forward position with respect to the sleeve 112. The collar 102 is spring biased by a collar spring 106 towards the forward position as shown in FIG. 1. The user can pull back on the collar 102 with respect to the sleeve 112 which moves the collar 102 away from the bit 134. This movement of the collar 102 also moves the bit locking element 104 in the same direction.

Since the locking element through hole 124 is inclined with respect to the longitudinal axis 130, the bit locking element 104 moves away from engagement with the reciprocal notch 136 when the collar 102 is pulled back. Accordingly, the bit 134 is free to be removed from the bit holder 100 when the bit locking element 104 has disengaged from the reciprocal notch 136.

The bit holder 100 comprises a retaining magnet 114, so that the bit 134 does not accidentally fall out of the sleeve 112 when the user releases the bit locking element 104 with the collar 102. For example, if the user actuates the collar 102 when the bit holder 100 is facing downwards, the retaining magnet 114 will prevent the bit 134 from slipping out of the sleeve 112.

The retaining magnet 114 is arranged to exert a magnetic force on the ferrous bit 134 when the bit 134 is inserted into the sleeve 112. The retaining magnet 114 and its assembly will now be described in reference to FIGS. 2, 3A, 3B, FIG. 4A and 4B.

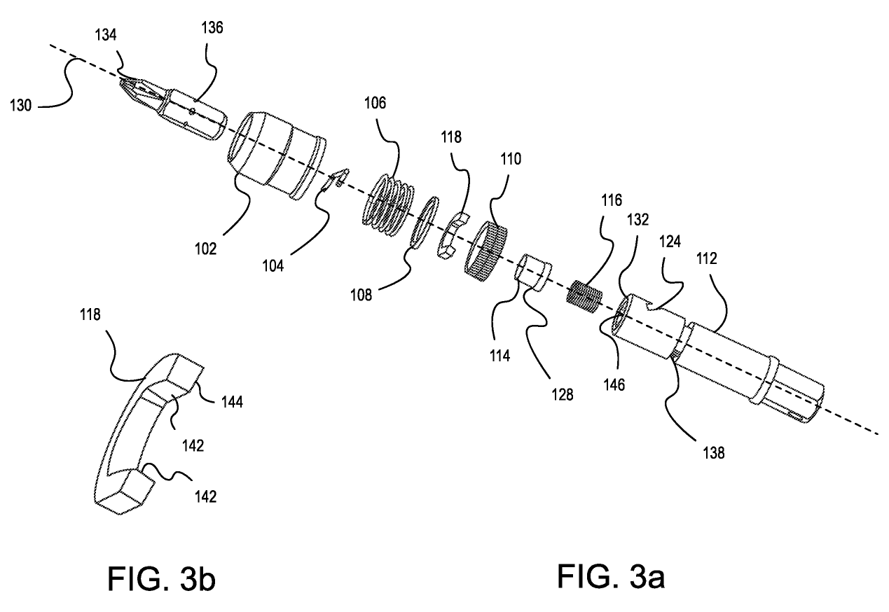

FIG. 3a shows an exploded perspective view of the bit holder 100. FIG. 3B shows a close-up view of a component, e.g. a retaining clip 118 of the bit holder 100.

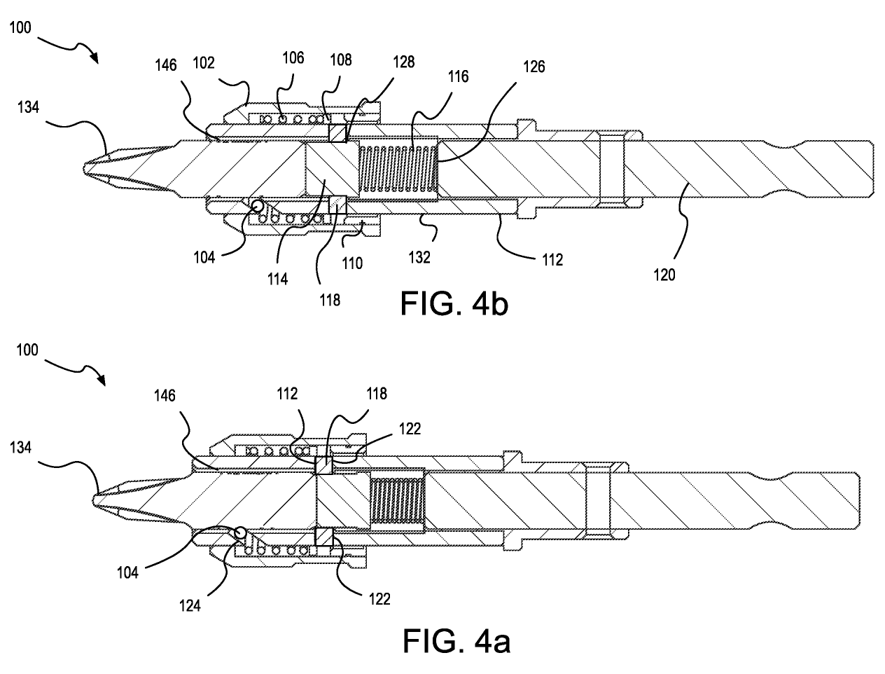

FIG. 4A and 4B show cross-sectional side diagrams of the bit holder 100 with the retaining magnet 114 in different positions.

The retaining magnet 114 is mounted within the sleeve bore 146 and secures the bit 134 to the bit holder 100. The user simply pulls the bit 134 away from the retaining magnet 114 in order to release the bit 134 from the bit holder 100. The retaining magnet 114 is moveable within the sleeve bore 146. Specifically, the retaining magnet 114 is moveable between a first position as shown in FIG. 4a and a second position as shown in FIG. 4b.

When the retaining magnet 114 is in the first position, as shown in FIG. 4A, the bit 134 is fully seated within the sleeve bore 146. Furthermore, when the bit 134 is fully seated in the sleeve bore 146 and the retaining magnet 114 is in the first position, the bit locking element 104 engages the reciprocal notch 136. Since the bit locking element 104 retains the bit 134 in the bit holder 100, this also prevents the retaining magnet 114 from moving from the first position to the second position.

When the bit 134 is inserted into the bit holder 100, the retaining magnet 114 is pushed back towards the bar 120 and compresses a magnet spring 116. The magnet spring 116 is mounted between the retaining magnet 114 and the bar end 126 of the bar 120. As shown in FIG. 4a, the magnet spring 116 is in a compressed state. Accordingly, the retaining magnet 114 urges against the bit 134.

When the retaining magnet 114 is in the second position, the retaining magnet 114 has moved in a direction parallel with the longitudinal axis 130 away from the bar end 126. Since the bit locking element 104 no longer engages the reciprocal notch 136, the bit 134 is moveable with respect to the sleeve 112. This also means that the retaining magnet 114 is also moveable with respect to the sleeve 112.

As the retaining magnet 114 moves from the first position to the second position, this causes the retaining magnet 114 to push the bit 134 out of the sleeve bore 146. Accordingly, as shown in FIG. 4B, the bit 134 is partially ejected from the bit holder 100. As mentioned above, the magnet spring 116 causes the retaining magnet 114 to move from the first position to the second position.

The retaining magnet 114 is restricted in the range of movement within the sleeve bore 146. That is, the retaining magnet 114 can only move from the first position to the second position.

This means that the retaining magnet 114 cannot move any further away from the bar end 126 than the second position as shown in FIG. 4b.

In order to define the second position and prevent the retaining magnet 114 from exiting the sleeve bore 146, a retaining element 118 engages a portion of the retaining magnet 114 in the second position. In some examples, the retaining element 118 is a retaining clip 118, which protrudes through a clip through hole 122.

The clip through hole 122 is connected to the sleeve bore 146. This means that the retaining clip 118 can be mounted to the sleeve 112 on the outside of the sleeve 112, and then a portion of the retaining clip 118 can project into the sleeve bore 146.

As shown in FIG. 4b, a portion of the retaining clip 118 projects into the sleeve bore 146 and engages a magnet shoulder 128. The magnet shoulder 128 is a circumferential portion of the retaining magnet 114 that has a greater diameter than the rest of the retaining magnet 114. The retaining clip 118 engages the retaining magnet 114 against the magnet shoulder 128. In some examples, the retaining clip 118 can engage any suitable portion of the retaining magnet 114. For example, the retaining magnet 114 can have a slot (not shown) into which the retaining clip 118 projects. Alternatively, the retaining clip 118 can engage any surface of the retaining magnet 114 when the retaining magnet 114 is in the second position. In some examples, the retaining clip 118 is a side mounted retaining ring.

FIG. 3b shows the retaining clip 118, which will be discussed in more detail. In some examples, the retaining clip 118 is a C-clip, as shown in FIG. 3b. The retaining clip 118 comprises a clip magnet engagement surface 144, which engages the magnet shoulder 128. The clip magnet engagement surface 144 is a surface of the retaining clip 118 that faces the retaining magnet 114 when both the retaining clip 118 and the retaining magnet 114 are mounted in the sleeve bore 146.

The retaining clip 118, as shown in the accompanying figures is illustrated as a C-clip. However, in other examples, the retaining clip 118 can be any suitable retaining element 118 for retaining the magnet. In some alternative examples, the retaining clip 118 can be an E-clip, a snap clip or any other element arranged to mount around the outside of the sleeve 112 and project into the sleeve bore 146 via the clip through hole 122.

The retaining clip 118 can have any suitable shape or profile in order to protrude into the sleeve bore 146 and engage the retaining magnet 114 in the second position. The retaining clip 118 can be circular in shape. The retaining clip 118 can extend fully or partially in a circumferential direction around a circular path. Alternatively, the retaining clip 118 can have a non-circular shape or a partial circular shape. In some examples, the retaining clip 118 can have a semi-circular or half-moon shape. In this way, the retaining clip 118 has a curved edge and a rounded edge. In some alternative examples, the retaining clip 118 can have a “U” shape. The U-shaped retaining clip 118 has two straight extending arms, which can help seating and securing the retaining clip 118 on the sleeve 112 e.g. on reciprocal sleeve flat surfaces 140 as mentioned below.

In some examples the retaining clip 118 is an E-clip. Accordingly, the retaining clip 118 has three prongs that make contact with the sleeve 112 and provide a wider shoulder than other external rings for a larger retaining surface. In order to mount the retaining clip 118 on the sleeve 112, a side-mount retaining ring tool (not shown) can be used to push the retaining clip 118 into the groove 138 from the side of the sleeve 112. If the retaining clip 118 is an alternatively clip e.g. a C-clip, a similar a side-mount retaining ring tool (not shown) can be used to push the retaining clip 118 into the groove 138.

Optionally, the retaining clip 118 is made from 1060-1090 spring steel. Optionally, additionally the retaining clip 118 comprises a black-phosphate finish which is mildly corrosion resistant in dry environments. Alternatively, the retaining clip 118 in some examples comprises a zine yellow-chromate plated finish which has some corrosion resistance in wet environments. Alternatively, in some other examples, the retaining clip 118 comprises a zinc chromate plated finish which a has good corrosion resistance.

Optionally, the retaining clip 118 is made from DIN 1.4122 stainless steel. This means that the retaining clip 118 can withstand wear caused by abrasion, similar to 400 series stainless steel. Optionally the retaining clips 118 are passivated for added protection against corrosion.

In some examples, a portion of each arm of the retaining clip 118 is arranged to project into the sleeve bore 146 via a separate clip through hole 122. In this way, the sleeve 112 comprises a plurality of clip through holes 122 each arranged to receive a portion of the retaining clip 118. As shown in FIGS. 4a and 4b, the clip through holes 122 are arranged on diametrically opposite sides of the sleeve 112. This means that the retaining clip 118 can engage the retaining magnet 114 at multiple points. This prevents the magnet spring 116 from creating a turning moment against the retaining magnet 114 in the second position. This helps prevent the retaining magnet 114 from jamming in the sleeve bore 146. In some other examples, there can be any suitable number of clip through holes 122. Indeed, there can be a single clip through hole 122.

During assembly, the ends of the retaining clip 118 are widened e.g. with a tool and the sleeve 112 is inserted within the retaining clip 118. The retaining clip 118 then snaps into place when assembled on the sleeve 112. In order to secure the retaining clip 118 at specific position along the longitudinal axis 130, the retaining clip 118 is mounted in a groove 138 on the sleeve 112.

The groove 138 is circumferential around the sleeve 112 and is arranged to receive the retaining clip 118. The groove 138 in some examples is a circumferential groove 138 around the sleeve 112. Alternatively, the groove 138 can partially extend around the sleeve 112.

As shown in FIG. 2, the groove 138 is approximately the same width as the width of the retaining clip 118. Furthermore, as shown in FIG. 2, the clip through hole 122 is aligned with the groove 138. That is the clip through hole 122 is positioned within the groove 138. In the example where there are two clip through holes 122, both clip through holes 122 are positioned within the groove 138.

Furthermore, in order to limit the rotational movement of the retaining clip 118 around the longitudinal axis 130, one or more features can be provided to stop relative movement there between.

In some examples the sleeve 112 comprises a sleeve flat surface 140 arranged to engage a reciprocal clip sleeve engagement surface 142 on the retaining clip 118. The clip sleeve engagement surface 142 is also a flat surface. When the retaining clip 118 is mounted in the clip through hole 122, the clip sleeve engagement surface 142 is adjacent to the sleeve flat surface 140. This prevents rotational movement of the retaining clip 118 about the longitudinal axis 130.

Whilst FIG. 2 only shows one sleeve flat surface 140 in some examples there are two sleeve flat surfaces 140 on opposite sides of the sleeve 112.

In order to prevent ingress of dirt or moisture the collar 102 comprises a sealing ring 110. Furthermore, a gasket 108 can be provided between the collar spring 106 and the retaining clip 118. When assembled, the collar 102 covers the clip through holes 122 and the retaining clip 118. This means that the retaining clip 118 is not easily disassembled by the user. Furthermore, the collar 102 covers the collar 102 covers the clip through holes 122 and the retaining clip 118 irrespective of the relative position of the collar 102 with respect to the sleeve 112.

The arrangement as shown in the accompanying figures means that the bit holder 100 requires fewer components and is easier to assemble. For example, the magnet spring 116 does not need to be attached to the retaining magnet 114 or that the retaining magnet 114 is mounted in an additional movable element.

Indeed, the retaining magnet 114 can be pushed into the sleeve bore 146 whilst compressing the magnet spring 116 against the bar end 126 and the retaining clip 118 is mounted to the sleeve 112 when the retaining magnet 114 is in the first position. This can be a simple two-handed job or indeed an automated process. No subassembly of components is required before final assembly of the bit holder 100.

Accordingly, the magnet arrangement and the locking mechanism of the bit holder 100 is simpler and less complex. In some examples, the locking mechanism of the bit holder 100 is optional. In this less preferred example, the bit 134 will be automatically partially ejected from the bit holder 100 when the user does not exert a force on the bit 134 in a direction parallel with the longitudinal axis 130. Accordingly, the advantages of the simpler construction provided by the retaining clip 118 can still be achieved without the bit locking element 104, the collar 102, or the collar spring 106.

In another example, two or more examples are combined. Features of one example can be combined with features of other examples.

Examples of the present disclosure have been discussed with particular reference to the examples illustrated. However, it will be appreciated that variations and modifications may be made to the examples described within the scope of the disclosure.

The terminology used herein is for the purpose of describing particular aspects only and is not intended to be limiting of the disclosure. As used herein, the singular forms "a," "an," and "the" are intended to include the plural forms as well, unless the context clearly indicates otherwise. As used herein, the term "and/or" includes any and all combinations of one or more of the associated listed items. It will be further understood that the terms "comprises," "comprising," "includes," and/or "including" when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as "below" or "above" or "upper" or "lower" or "horizontal" or "vertical" may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being "connected" or "coupled" to another element, it can be directly connected or coupled to the other element, or intervening elements may be present. In contrast, when an element is referred to as being "directly connected" or "directly coupled" to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealised or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A bit holder comprising:
a sleeve having a bore for receiving a bit and a through-hole in a wall of the sleeve connected to the bore;
a magnet arranged to engage the bit and wherein the magnet is moveable within the bore between a first position when the bit is seated in the bore and a second position when the bit is partially ejected from the bore; and
a magnet retaining element mounted in the through-hole and arranged to protrude into the bore and engage a portion of the magnet when the magnet is in the second position.

2. The bit holder of claim 1, wherein the bit holder comprises a magnet spring arranged to urge the magnet from the first position towards the second position.

3. The bit holder of claim 1, wherein the magnet retaining element is a clip.

4. The bit holder of claim 3, wherein the clip is a C-clip, or an E-clip.

5. The bit holder of claim 1, wherein the magnet comprises a shoulder portion arranged to engage the magnet retaining element when the magnet is in the second position.

6. The bit holder of claim 1, wherein the through-hole extends through the wall of the sleeve in a direction perpendicular to a longitudinal axis of the bit holder.

7. The bit holder of claim 1, wherein the magnet projects through the magnet retaining element in a direction parallel with a longitudinal axis of the bit holder when the magnet is in the second position.

8. The bit holder of claim 1, wherein the magnet is arranged to move from the second position to the first position when a bit is inserted into the bore.

9. The bit holder of claim 1, wherein the bit holder comprises a bit locking element arranged to protrude into the bore and engage a reciprocal notch on the bit when the bit is seated in the bore and the magnet is in the first position.

10. The bit holder of claim 9, wherein the bit locking element is mounted in a locking element through-hole in the wall of the sleeve.

11. The bit holder of claim 9, wherein the locking mechanism comprises a release collar slidably mounted on the sleeve and arranged to disengage the bit locking element from the reciprocal notch when the release collar is moved from a locked position to a release position.

12. The bit holder according to claim 11, wherein the release collar covers the through-hole.

13. The bit holder of claim 10, wherein the release collar comprises a collar spring arranged to urge the release collar from the release position to the locked position.

14. The bit holder of claim 1, wherein the retaining element and comprises at least one flat surface arranged to engage a reciprocal flat surface on the sleeve.

15. The bit holder of claim 1, wherein the sleeve comprises a circumferential groove arranged to receive the retaining element.
